(19) United States
(12) Patent Application Publication
(10) Pub. No.: US 2013/0232319 A1
(43) Pub. Date: Sep. 5, 2013

(54) INFORMATION PROCESSING SYSTEM, ROUTING METHOD AND PROGRAM

(71) Applicant: FUJITSU LIMITED, Kawasaki-shi (JP)

(72) Inventor: Toru KONO, Sagamihara (JP)

(73) Assignee: FUJITSU LIMITED, Kawasaki-shi (JP)

(21) Appl. No.: 13/862,858

(22) Filed: Apr. 15, 2013

Related U.S. Application Data
(63) Continuation of application No. PCT/JP2010/069214, filed on Oct. 28, 2010.

(51) Int. Cl. G06F 15/80

(52) U.S. Cl. CPC G06F 15/803
USPC 712/12

(57) ABSTRACT

A disclosed information processing system includes 2ⁿ nodes that are connected in a manner of an n-dimensional hyper cube, wherein the n is a natural number equal to or greater than 3. A channel is provided between each node of specific nodes satisfying a predetermined condition among the 2ⁿ nodes and each of the specific nodes other than the node, and the predetermined condition is a condition that all numerical values of digits other than a last digit and a second last digit of a node number are same, in case where an n-digit binary node number is assigned to each of the 2ⁿ nodes so that a Hamming distance between directly connected nodes is 1.

### CROSS-REFERENCE TO RELATED APPLICATIONS

This application is a continuing application, filed under 35 U.S.C. section 111(a), of International Application PCT/JP2010 /069214 filed on Oct. 28, 2010.

### FIELD

This technique relates to a topology of a network and a routing technique.

### BACKGROUND

When it is attempted to shorten the latency between nodes (for example, processors) in an information processing system, it is effective to use a fully coupled network that connects all of the nodes by Point-to-Point. The fully coupled network is a network such as illustrated in FIG. 1. However, even though the fully coupled network is effective for shortening the latency, when the scale of the network increases (in other words, the number of nodes increases) the number of physical channels greatly increases, so there may be problems due to expansion costs and the difficulty of implementation.

Therefore, in a large-scale network, with the intention to reduce the number of physical channels, a network having a link structure, such as a Hyper Cube type network, may be used. A Hyper Cube type network is a network such as illustrated in FIG. 2, where FIG. 2 illustrates a 3-dimensional Hyper Cube type network. In the Hyper Cube type network, a node is placed at each apex of the Hyper Cube, and in the case of an n-dimensional Hyper Cube type network, each node is directly connected to Log₂n nodes.

FIG. 3 illustrates the relationship between the number of nodes and the number of channels for the fully coupled network and Hyper Cube type network. The vertical axis in FIG. 3 represents the number of channels, and the horizontal axis represents the number of nodes. As illustrated in FIG. 3, in case of the Hyper Cube type network, even though the number of nodes increases, the number of channels does not increase as much as in the case of the fully coupled network.

Incidentally, the Deterministic Routing that is used for Hyper Cube type network is typically e-cube routing. The e-cube routing is also called dimension order routing, and by performing the routing such that channels are used in order from channels in a dimensional direction having the highest priority, data is transferred to a destination node from the transmitting node. The e-cube routing can be achieved by relatively simple logical circuits, so the nodes do not need to have a routing table for storing routing information. Moreover, in the case of an interconnected Hyper Cube type network, a deadlock free state in the e-cube routing is assured, so a virtual channel mechanism that is considered in the case of a torus type network is not necessary.

However, common problems in networks having a link structure are the appearance of long-distance links and an increase in the average number of hops as the scale of the network increases. These problems cause a lengthening of latency and become the cause of worsening processing performance.

In regards to such kinds of problems, there is a technique for transferring data between nodes across clusters by connecting to nodes in other clusters by adding one connecting line to each node in a Hyper Cube network having eight nodes (cluster).

Moreover, there is a technique for forming a group of PEs (Processing Elements) by adding bypass links between PEs having the greatest distance between the PEs in a Hyper Cube network.

However, in these techniques, it was not possible to sufficiently improve the communication efficiency in a Hyper Cube type network.

In other words, there is no effective technique for improving the communication efficiency in the hyper cube type network.

### SUMMARY

An information processing system relating to a first aspect of embodiments includes: 2ⁿ nodes that are connected in a manner of an n-dimensional hyper cube, wherein the n is a natural number equal to or greater than 3. A channel is provided between each node of specific nodes satisfying a predetermined condition among the 2ⁿ nodes and each of the specific nodes other than the node. The predetermined condition is a condition that all numerical values of digits other than a last digit and a second last digit of a node number are same, in case where an n-digit binary node number is assigned to each of the 2ⁿ nodes so that a Hamming distance between directly connected nodes is 1.

A routing method relating to a second aspect of the embodiments is executed by a first node of 2ⁿ nodes included in an information processing system, wherein the 2ⁿ nodes are connected in a manner of an n-dimensional hyper cube, the n is a natural number equal to or greater than 3, a channel is provided between each node of specific nodes satisfying a first condition among the 2ⁿ nodes and each of the specific nodes other than the node, and the first condition is a condition that all numerical values of digits other than a last digit and a second last digit of a node number are same, in case where an n-digit binary node number is assigned to each of the 2ⁿ nodes so that a Hamming distance between directly connected nodes is 1. Moreover, this routing method includes (A) when data is transmitted to a destination node, determining whether or not a second condition is satisfied, wherein the second condition is a condition that a numerical value of a last digit of a node number of the first node is different from a numerical value of a last digit of a node number of a destination node, and a numerical value of a second last digit of the node number of the first node is different from a numerical value of a second last digit of the node number of the destination node; and (B) in response to determining that the second condition is satisfied, transmitting data to be transmitted to the destination node to a second node through a channel provided between the first node and the second node, wherein the second node has a node number whose numerical value of a last digit is an inverted numerical value of the numerical value of the last digit of the node number of the first node, whose numerical value of a second last digit is an inverted numerical value of the numerical value of the second last digit of the node number of the first node, and whose numerical values of digits other than the last digit and the second last digit are same as numerical values of digits other than the last digit and the second last digit of the node number of the first node.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram to explain a fully coupled network;

FIG. 2 is a diagram to explain a Hyper Cube type network;

FIG. 3 is a diagram depicting a relationship between the number of nodes and the number of channels in the fully coupled network and Hyper Cube type network;

FIG. 4 is a diagram depicting a configuration of a 3-dimensional Hyper Cube type network;

FIG. 5 is a diagram depicting a configuration of an 8-node SSP Cube type network;

FIG. 6 is a diagram depicting a configuration of a 16-node SSP Cube type network;

FIG. 7 is a functional block diagram of a processor;

FIG. 8 is a diagram depicting a processing flow of a routing processing executed by a node;

FIG. 9 is a diagram depicting a relationship between the number of nodes and the number of channels in the fully coupled network and SSP Cube type network;

FIG. 10 is a diagram to explain a feature of the Hyper Cube type network and SSP Cube type network;

FIG. 11 is a diagram representing a relationship between the number of nodes and the number of channels for the Hyper Cube type network and SSP Cube type network;

FIG. 12 is a diagram to explain broadcasting in the Hyper Cube type network;

FIG. 13 is a diagram to explain broadcasting in the SSP Cube type network;

FIG. 14 is a diagram to explain a deadlock state;

FIG. 15 is a diagram to explain avoiding the deadlock state; and

FIG. 16 is a diagram depicting a computer system to which the SSP Cube type network is applied.

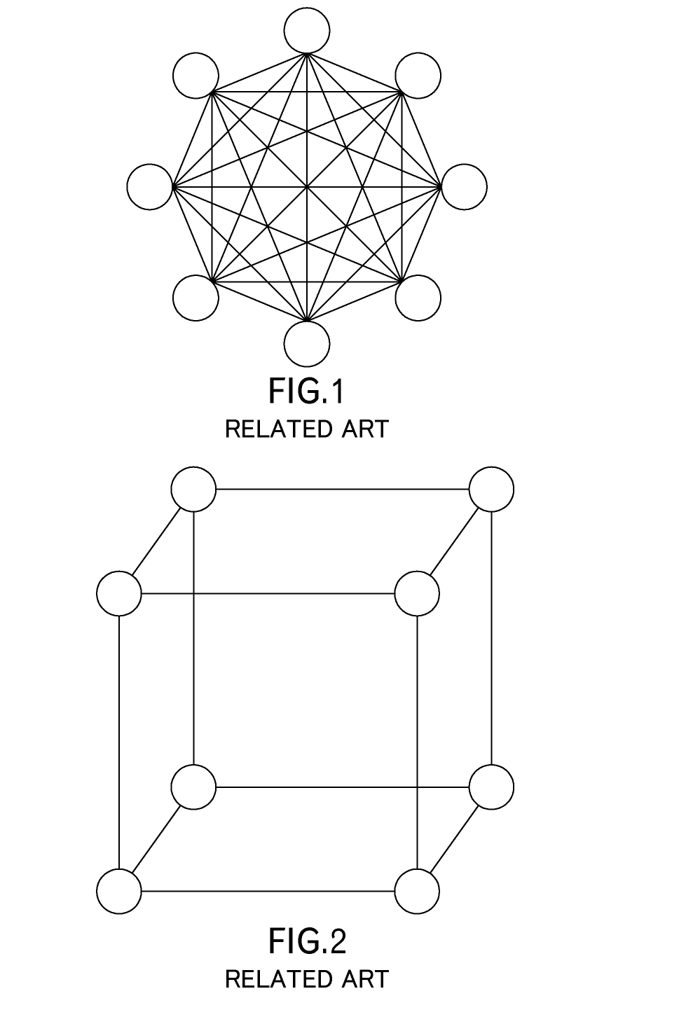

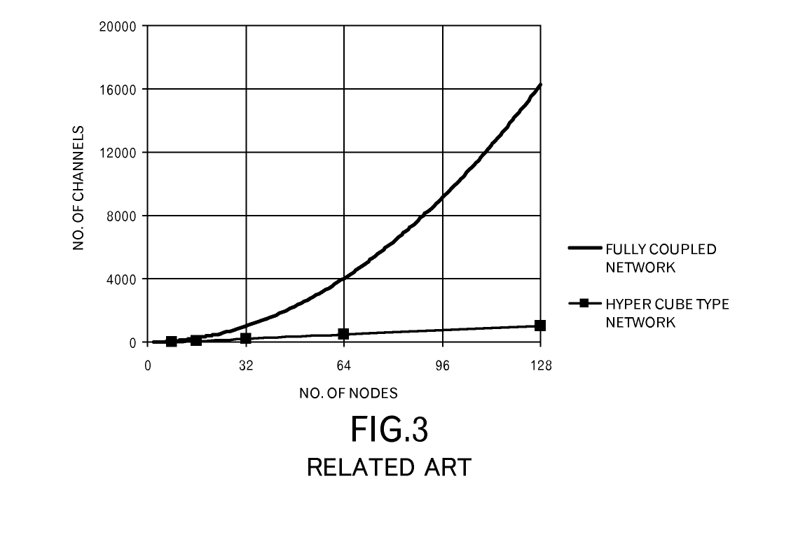

### DESCRIPTION OF EMBODIMENTS

First, the shape of the network relating to this embodiment will be explained. The shape of the network relating to this embodiment is a subspecies cube shape, which uses the interconnected hyper cube type network as the basic structure. Hereafter, the network relating to this embodiment will be called a “SSP Cube type network”. Here, SSP is an abbreviation for “Subspecies”.

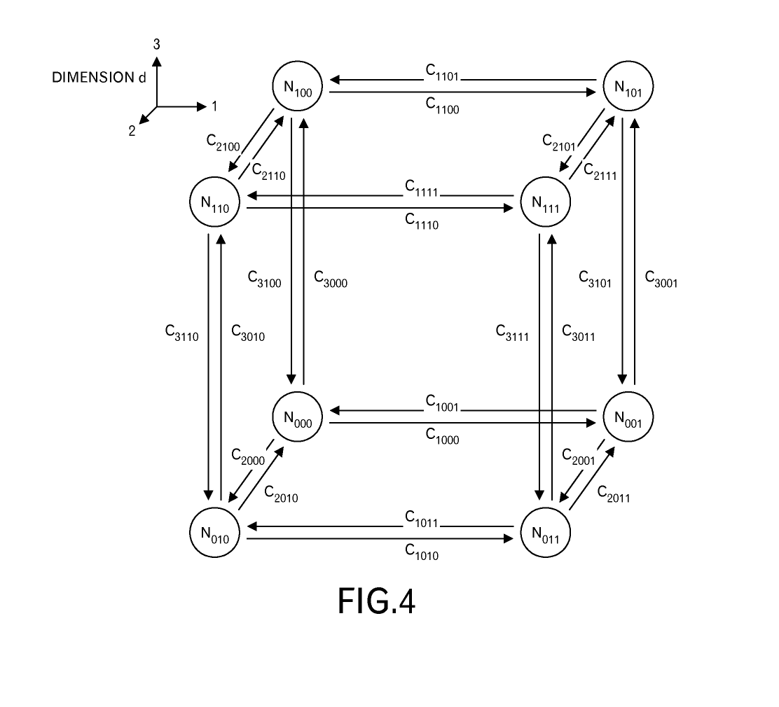

For example, the basic structure of an 8-node SSP Cube type network is a 3-dimensional Hyper Cube type network such as illustrated in FIG. 4. In FIG. 4, n-digit (here, n=3) binary node number is assigned to each node, and nodes are connected so that the Hamming distance of the node numbers between directly connected nodes (in other words, nodes connected with one link) is 1. Such assignment of the node numbers is the same as the method of assigning the node numbers, which is typically performed for the Hyper Cube type network. To make it easier to view the figure, an “N” is attached to the top of each node number.

Moreover, for each node, an output channel having a channel number “C_{dk}” is provided for each dimension d, and through these channels, the nodes are connected to other nodes. Here, d represents the dimension number, and k represents the node number. For example, a node whose node number is “000” connects to the node whose node number is “001” byway of an output channel whose channel number is “1000”, connects to the node whose node number is “010” by way of an output channel whose channel number is “2000”, and connects to the node whose node number is “100” by way of an output channel whose channel number is “3000”. To make the figure easier to view, a “C” is attached to channel numbers.

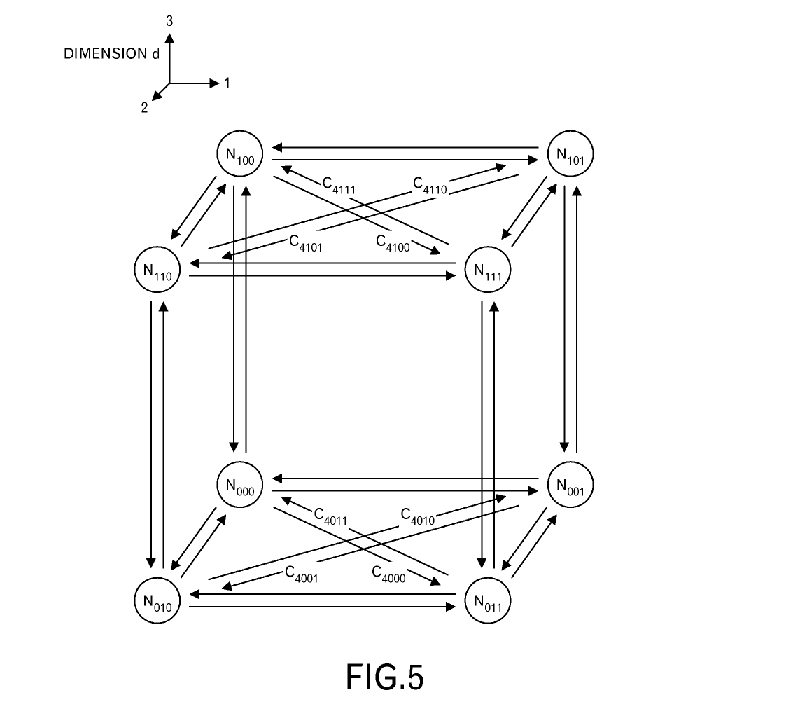

A SSP Cube type network having 8 nodes is obtained by further adding channels to the 3-dimensional Hyper Cube type network that is illustrated in FIG. 4, and is a network as illustrated in FIG. 5. More specifically, an output channel whose channel number is “4000” is added to the node whose node number is “000” and connected to the node whose node number is “011”, an output channel whose channel number is “4001” is added to the node whose node number is “001” and connected to the node whose node number is “010”, an output channel whose channel number is “4010” is added to the node whose node number is “010” and connected to the node whose node number is “001”, an output channel whose channel number is “4011” is added to the node whose node number is “011” and connected to the node whose node number is “000”, an output channel whose channel number is “4100” is added to the node whose node number is “100” and connected to the node whose node number is “111”, an output channel whose channel number is “4101” is added to the node whose node number is “101” and connected to the node whose node number is “110”, an output channel whose channel number is “4110” is added to the node whose node number is “110” and connected to the node whose node number is “101”, and an output channel whose channel number is “4111” is added to the node whose node number is “111” and connected to the node whose node number is “100”. In other words, to a node on the side that outputs data, an output channel having a channel number that is C₍ₙ₊₁₎ₖ (here n=3) is added for nodes of which the numerical values of the last digit and second last digit of the node numbers are different, and the numerical values of all of the digits other than the last digit and second last digit are the same. Here, in order to make the figure easier to view, channel numbers have been given only to newly added channels.

When output channels are added in this way, each node in a group of four nodes whose numerical values of digits other than the last digit and second last digit of the node numbers are the same also has output channels for all of the other nodes in the same group. In other words, each surface in one set of opposing surfaces in an 8-node cube becomes a fully coupled network, and multi-area structure is achieved. Therefore, a SSP Cube type network cannot be constructed unless there are at least 8 nodes, and a condition for the number of nodes 2^{m} (m is a natural number 3 or greater) is required.

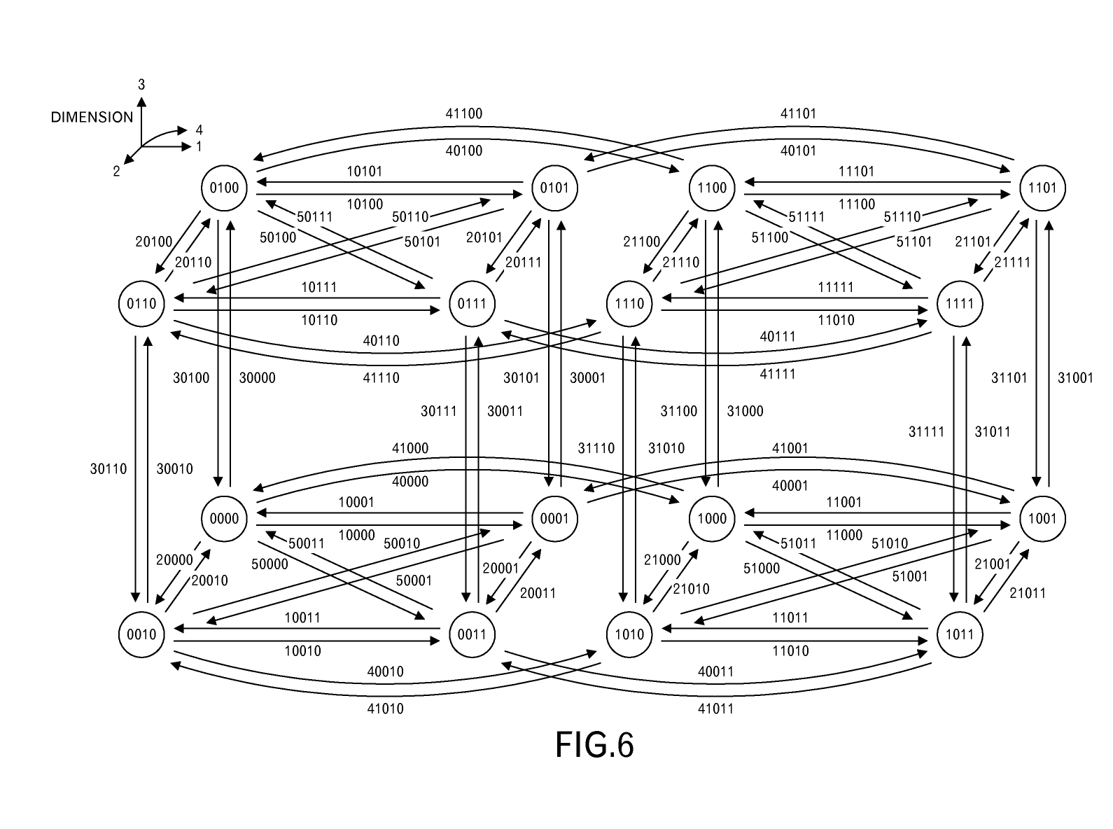

FIG. 6 illustrates a configuration of a SSP Cube type network having 16 nodes. A 16-node SSP Cube type network is a network in which channels are further added to a 4-dimensional Hyper Cube type network. More specifically, an output channel whose channel number is “50000” is added to a node whose node number is “0000” and connected to a node whose node number is “0011”, an output channel whose channel number is “50001” is added to a node whose node number is “0001” and connected to a node whose node number is “0010”, an output channel whose channel number is “50010” is added to a node whose node number is “0010” and connected to a node whose node number is “0001”, an output channel whose channel number is “50011” is added to a node whose node number is “0011” and connected to a node whose node number is “0000”, an output channel whose channel number is “50100” is added to a node whose node number is “0100” and connected to a node whose node number is “0111”,an output channel whose channel number is “50101” is added to a node whose node number is “0101” and connected to a node whose node number is “0110”, an output channel whose channel number is “50110” is added to a node whose node number is “0110” and connected to a node whose node number is “0101”, an output channel whose channel number is “50111” is added to a node whose node number is “0111” and connected to a node whose node number is “0100”, an output channel whose channel number is “51000” is added to a node whose node number is “1000” and connected to a node whose node number is “1011”, an output channel whose channel number is “51001” is added to a node whose node number is “1001” and connected to a node whose node number is “1010”, an output channel whose channel number is “51010” is added to a node whose node number is “1010” and connected to a node whose node number is “1001”, an output channel whose channel number is “51011” is added to a node whose node number is “1011” and connected to a node whose node number is “1000”, an output channel whose channel number is “51100” is added to a node whose node number is “1100” and connected to a node whose node number is “1111”, an output channel whose channel number is “51101” is added to a node whose node number is “1101” and connected to a node whose node number is “1110”, an output channel whose channel number is “51110” is added to a node whose node number is “1110” and connected to a node whose node number is “1101”, and an output channel whose channel number is “51111” is added to a node whose node number is “1111” and connected to a node whose node number is “1100”. In other words, as in the case of an 8-node SSP Cube type network, an output channel having a channel number C₍ₙ₊₁₎ₖ (here n=4) is added to a node on the side that outputs data, for nodes of which the numerical values of the last digit and second last digit of the node numbers are different, and the numerical values of all of the digits other than the last digit and second last digit are the same.

Moreover, even in the case of the 16-node SSP Cube type network, each node in a group of four nodes whose digits other than the last digit and second last digit have the same numerical values have output channels to all of the other nodes in the same group. In other words, one set of opposing surfaces in an 8-node cube forms a fully coupled network, and multi-area structure is achieved.

In the examples described above, 8-node and 16-node SSP Cube type networks were explained, however, as long as the number of nodes is 2^{m} (m is a natural number 3 or greater), it is possible to construct a SSP Cube type network.

Next, the routing processing that is performed in a SSP Cube type network will be explained.

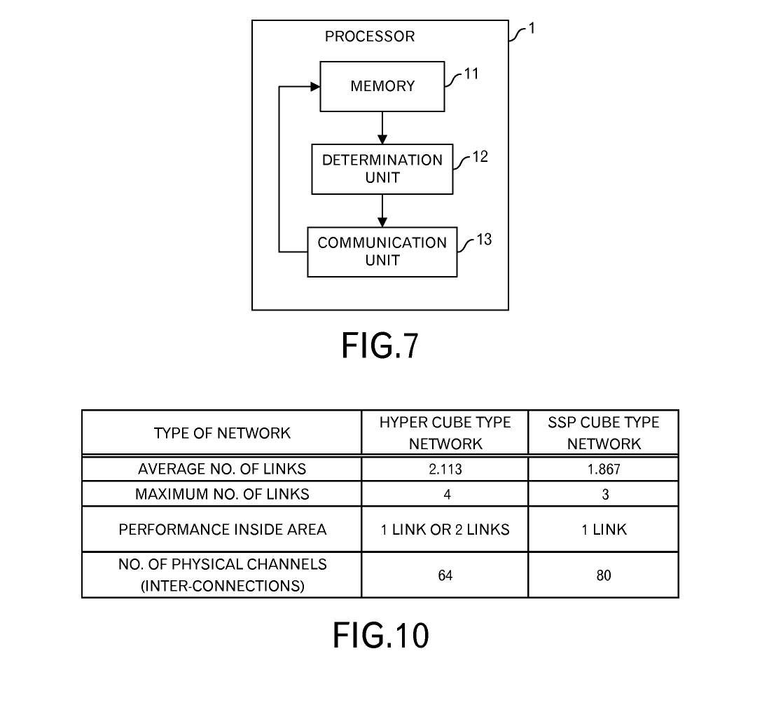

FIG. 7 illustrates a functional block diagram of a node in a SSP Cube type network. Node 1, which is, for example, a processor, includes a memory 11 that stores data and the like, which is received from other nodes in the SSP Cube type network, a determination unit 12 that performs a processing to determine a node or the like to which data is to be transmitted, and a communication unit 13 that performs a processing for transmitting data to a node that was determined by the determination unit 12, and performs a processing for storing received data in the memory 11.

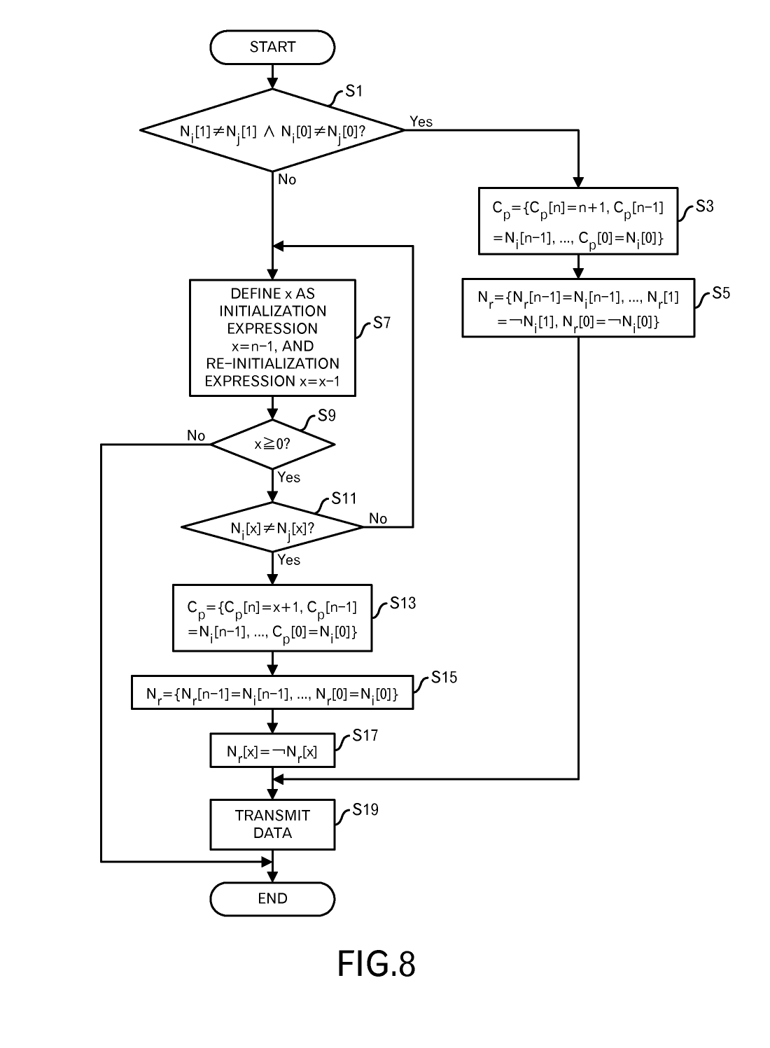

Next, FIG. 8 will be used to explain the processing that is performed by the node 1 illustrated in FIG. 7. In the following, the node number of node 1 is N₁, and 0-th bit of N₁ (in other words, the first digit) is expressed as Nᵢ[0]. By using this, Nᵢ is represented as Nᵢ={Nᵢ[n−1], Nᵢ[n−2], . . . , Nᵢ[1], Nᵢ[0]} (n is the number of dimensions of the Hyper Cube type network that is the basic structure of the SSP Cube type network). A similar expression is used for node number Nⱼ of the node where data is finally to be transmitted (hereafter, called the destination node), the node number Nᵣ of a node where data is transmitted (hereafter, called a routed node), and the channel number Cₚ of a channel that is used when transmitting data to a routed node (hereafter, called a passage channel).

First, the determination unit 12 reads data from the memory 11, which is to be transmitted to the destination node, compares the node number of the destination node, which is given to that data with the node number of node 1, and determines whether both the last digits and the second last digits in the node numbers are different (FIG. 8: step S1). Namely, it is determined whether or not “Nᵢ[1]≠Nⱼ[1] [symbol] Nᵢ[0]≠Nⱼ[0]” is satisfied.

Then, when it is determined that “Nᵢ[1]≠Nⱼ[1] [symbol] Nᵢ[0]≠Nᵢ[0]” is satisfied (step S1: YES route), the determination unit 12 determines, as the channel number Cₚ of the passage channel, a channel number where the numerical value of the most significant digit is n+1, and the numerical values of digits other than the most significant digit are the same as the node number of node 1 (step S3). In other words, Cₚ={Cₚ[n]=n+1, Cₚ[n−1]=Nᵢ[n−1], . . . , Cₚ[1]=Nᵢ[1], Cₚ[0]=Nᵢ[0]} is obtained.

The determination unit 12 determines, as the node number Nᵣ of the routed node, the node number in which the numerical value of the last one digit is the inverted value of the last digit of the node number of node 1, and the numerical value of the second last digit is the inverted value of the second last digit of the node number of node 1, and the values of the digits other than the last digit and second last digit are the same as the values of the digits other than the last digit and second last digit of the node number of node 1 (step S5). In other words, Nᵣ={Nᵣ[n−1]=Nᵢ[n−1], Nᵣ[n−2]=Nᵢ[n−2], . . . , Nᵣ[1]= [symbol] Nᵢ[1], Nᵣ[0]= [symbol] Nᵢ[0]} is obtained.

The communication unit 13 then transmits the data to be transmitted to the destination node to the routed node that was determined at the step S5 by way of the passage channel that was determined at the step S3 (step S19).

On the other hand, when it was determined at the step S1 that “Nᵢ[1]≠Nⱼ[1] [symbol] Nᵢ[0]≠Nⱼ[0]” is not satisfied (step S1: NO route), the determination unit 12 defines x with the initialization equation x=n−1, and the re-initialization equation x=x−1 (step S7). In other words, when x is already defined, x is redefined as x=x−1, and when x has not yet been defined, x is defined as x=n−1.

The determination unit 12 then determines whether x≧0 is satisfied (step S9). When it is determined that x≧0 is not satisfied (step S9: NO route), the processing ends.

However, when it is determined that x≧0 (step S9: YES route), the determination unit 12 determines whether the numerical value of x-th bit in the node number of node 1 is different than the x-th bit number in the node number of the destination node (step S11). In other words, it is determined whether or not Nᵢ[x]≠Nⱼ[x] is satisfied.

When it is determined that Nᵢ[x]≠Nⱼ[x] is not satisfied, or in other words, when it is determined that Nᵢ[x]=Nⱼ[x] (step S11: NO route), the processing returns to the step S7 in order to perform the processing for the next digit.

On the other hand, when it is determined that Nᵢ[x]≠Nⱼ[x] is satisfied (step S11: YES route), the determination unit 12 determines, as the channel number Cₚ of the passage channel, a channel number in which the numerical value of the most significant digit is x+1, and the numerical values of the digits other than the most significant digit are the same as those of the node number of node 1 (step S13). In other words, Cₚ={Cₚ[n]=x+1, Cₚ[n−1]=Nᵢ[n−1], . . . , Cₚ[1]=Nᵢ[1], Cₚ[0]=Nᵢ[0]} is obtained.

Moreover, the determination unit 12 determines, as the node number Nᵣ of the routed node, the same number as the node number of node 1 (step S15). In other words, Nᵣ={Nᵣ[n−1]=Nᵣ[n−1], Nᵣ[n−2]=Nᵢ[n−2], . . . , Nᵣ[1]=Nᵢ[1], Nᵣ[0]=Nᵣ[0]} is obtained. Furthermore, the determination unit 12 inverts the value of the x-th bit of the node number of the routed node that was determined at the step S15 (step S17). In other words, Nᵣ[x]= [symbol] Nᵣ[x] is obtained.

The communication unit 13 then transmits the data to be transmitted to the destination node to the routed node that was determined at the steps S15 and S17 by way of the passage channel that was determined at the step S13 (step S19). The processing then ends.

Here, the routing processing that was explained above will be explained using a simple detailed example. Here, the case of transferring data from the node whose node number is “000” to the node whose node number is “111” in the SSP Cube type network illustrated in FIG. 5 will be explained.

First, at the step S1, the node whose node number is “000” (hereafter, this will be expressed as N000, and will be the same for the other nodes as well), compares the node number of N000 with the node number of the destination node, and determines whether the numerical values of both the last digits and second last digits of the node numbers are different. Here, it is determined that the numerical values of both the last digits and second last digits are different.

Then at the step S3, the node N000 determines, as the number of the passage channel, “4000”, and at the step S5, determines, as the node number of the routed node, “011”. Then at the step S19, the node N000 transmits data to the node N011 by way of the channel whose channel number is “4000”.

On the other hand, when receiving data from the node N000, at the step S1, the node N011 compares the node number of the node N011 with the node number of the destination node, and determines whether the numerical values of both the last digits and second last digits of the node numbers are different. Here, the numerical values of both the last digits and the second last digits of the node numbers are the same. Therefore, at the step S7, x is defined as x=3−1=2, and after passing along the YES route at the step S9, it is determined at the step S11, whether the Nᵢ[2] in the node number of the node N011 is different from the Nⱼ[2] in the node number of the destination node. Here, it is determined that the values are different.

Then, at the step S13, the node N011 determines, as the channel number of the passage channel, “3011”, and, at the steps S15 and S17, determines, as the node number of the routed node, “111”. Then, at the step S19, the node N011 transmits data to the node N111 by way of the channel whose channel number is “3011”.

On the other hand, when receiving data from the node N011, at the step S1 the node N111 compares the node number of the node N111 with the destination node number, and determines whether the numerical values of both the last digits and second last digits of the node numbers are different. Here, the numerical values of both the last digits and second last digits of the node numbers are the same. Therefore, at the step S7, x is defined as x=3−1=2, and then after passing through the YES route at the step S9, it is determined at the step S11, whether the Nᵢ[2] in the node number of the node N111 is different than the Nⱼ[2] of the destination node number. Here, it is determined that the bits are the same and the transmitted data has reached the destination node, so the processing ends.

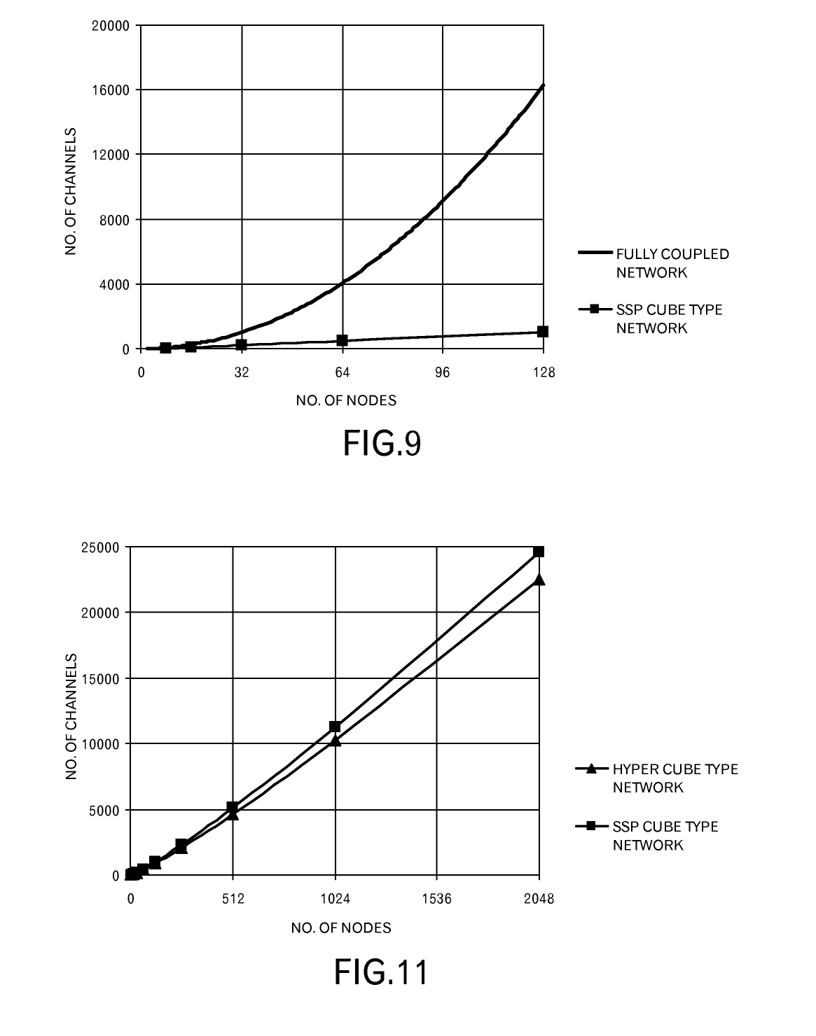

It is possible for a SSP Cube type network such as described above to reduce the total number of channels when compared with a fully coupled network. FIG. 9 illustrates the relationship between the number of nodes and the number of channels for a fully coupled network and SSP Cube type network. The vertical axis in FIG. 9 represents the number of channels, and the horizontal axis represents the number of nodes. As illustrated in FIG. 9, as the number of nodes increases (in other words, as the scale of the network increases), the effect becomes more notable. Because the number of channels is reduced, it is possible to reduce the manufacturing cost, and the difficulty of implementation is also decreased. Furthermore, by eliminating high-density wiring, it is also possible that the generation of the heat will be suppressed.

Even when compared with a Hyper Cube type network in which the e-cube routing is applied, the SSP Cube type network is advantageous in terms of communication efficiency. For example, as illustrated in FIG. 10, when comparing a 4-dimensional Hyper Cube type network with a 16-node SSP Cube type network, it can be seen that there is an advantage in the average number of links (average number of links to other nodes), and the maximum number of links. Moreover, when four fully coupled nodes are taken to be one area, it is possible to perform communication with one link to any of the nodes inside the area in a SSP Cube type network, and performance inside the area is also improved. However, in regards to the number of channels, there is a disadvantage when compared with a Hyper Cube type network. FIG. 11 illustrates the relationship between the number of nodes and number of channels in a Hyper Cube type network and SSP Cube type network. The vertical axis in FIG. 11 represents the number of channels, and the horizontal axis represents the number of nodes. As illustrated in FIG. 11, there is not an extreme increase in the number of channels when compared with a Hyper Cube type network, however, it is not possible to avoid a small increase in the number of channels.

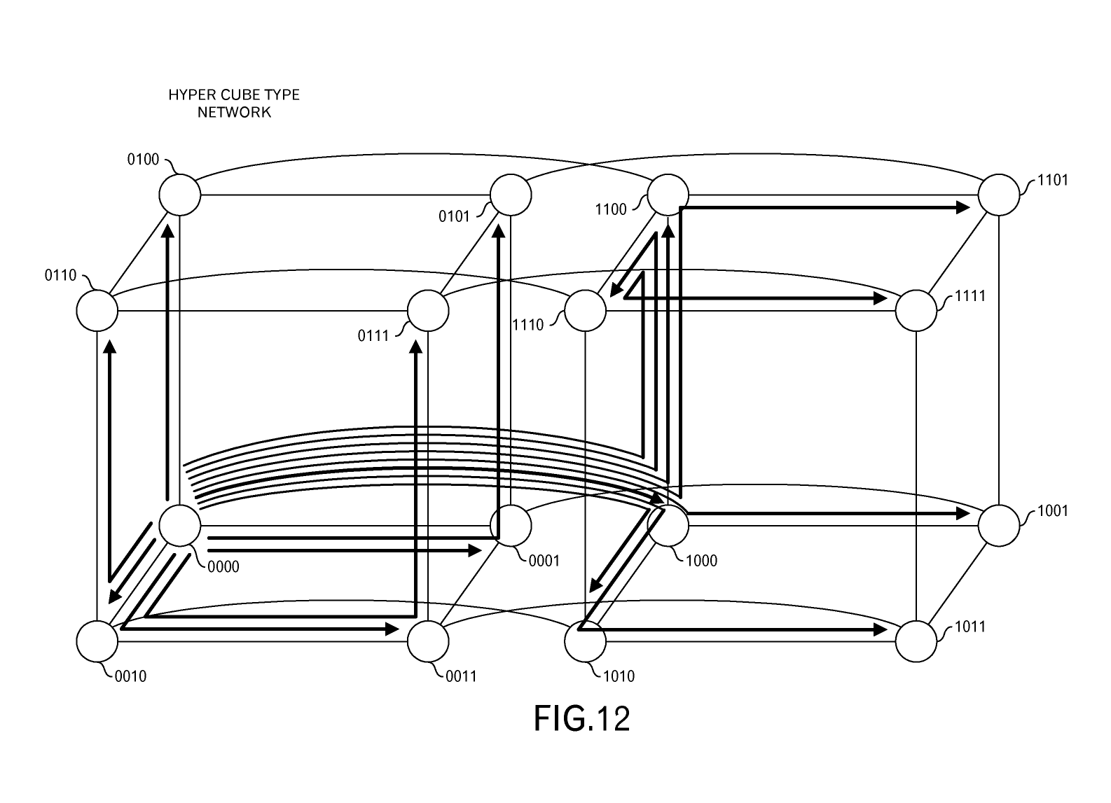

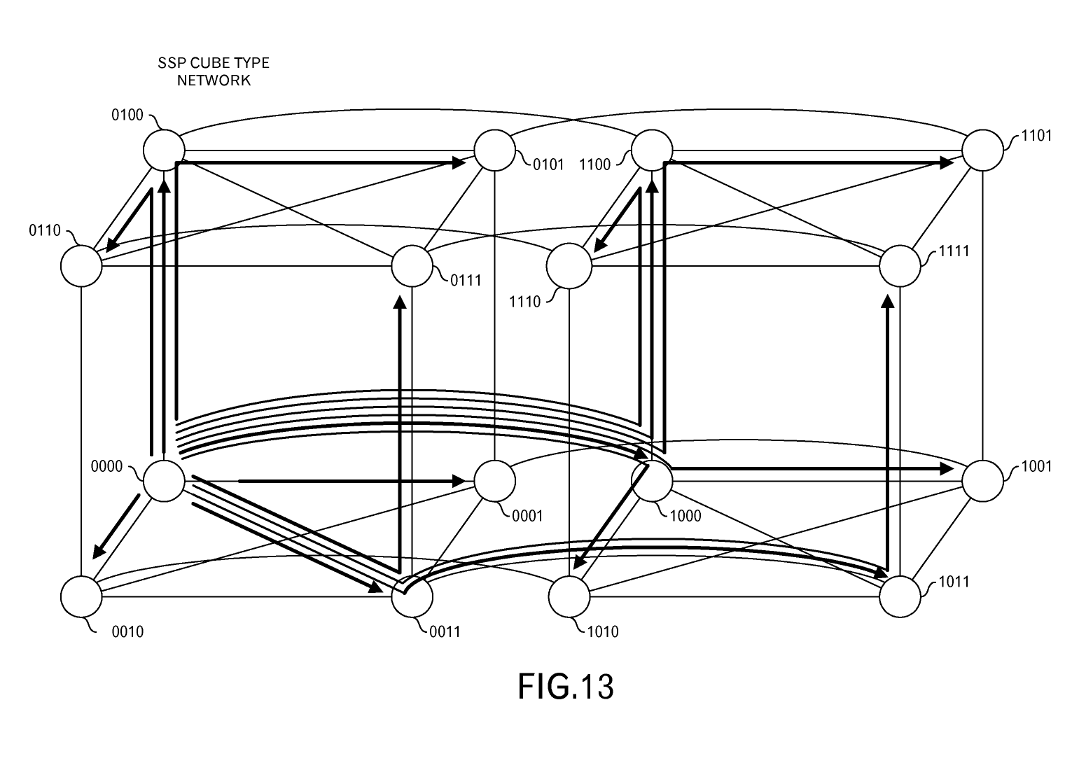

Furthermore, in comparison with a Hyper Cube type network, a SSP Cube type network has an advantage in the easing and dispersion of traffic in the network. For example, when each of the nodes performs communication with all of the other nodes in a network, 512 channels are used in a 4-dimensional Hyper Cube type network, however, in a 16-node SSP Cube type network, this number is kept to only 448 channels. In other words, together with being able to improve the effective latency, it is also possible to improve the total throughput. As a result, it is possible to maintain the throughput even though there is a drop in channel performance, so the total cost becomes lower than in the case of a Hyper Cube type network. Moreover, when comparing broadcasting in the Hyper Cube type network illustrated in FIG. 12 with the broadcasting in the SSP Cube type network illustrated in FIG. 13, it is possible for the SSP Cube type network to disperse the channels being used more than the Hyper Cube type network. As a result, an improvement in the broadcast performance can be expected.

Next, the deadlock free state will be considered.

Typically, except a network in which all of the nodes are interconnected, measures must be taken to prevent the occurrence of a deadlock state in which channels are fully used. In order to verify that deadlock free routing is being performed, a channel dependency graph is created, and it is represented that circulation does not occur in the channel dependency graph.

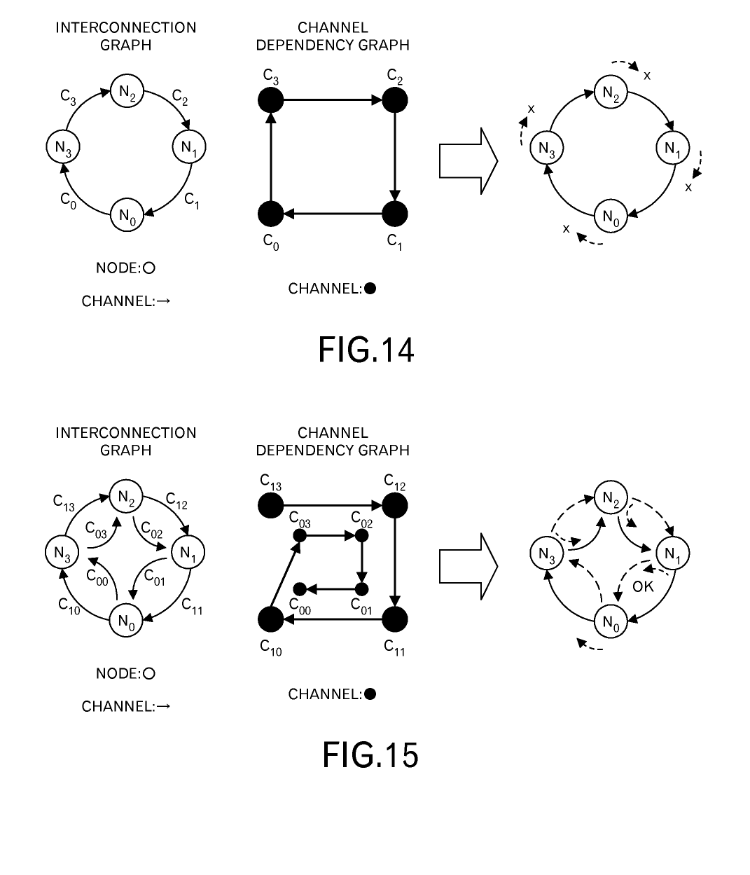

For example, in the case of a network such as that illustrated in the interconnection graph in FIG. 14, when each node transmits data to the second node in front of that node, all of the channels for transmitting data to the next node are completely used, and a deadlock state occurs. In a channel dependency graph that corresponds to this network, circulation occurs from channel C₀ to channel C₃.

Therefore, an output channel is added as illustrated in the interconnection graph in FIG. 15, and a routing method is set according to that. Here, when the node number is less than the node number of the destination node, a high channel (in other words, a channel for which the second digit of the channel number is 1) is used, and when the node number is greater than that of the destination node, a low channel (in other words, a channel for which the second digit of the channel number is 0) is used. However, channel C₀₀ is not used. As a result, not all of the channels are used even when each node is transmitting data to the second node in front of that node, so it is possible to avoid a deadlock state. Circulation does not occur in the channel dependency graph that corresponds to the network.

Therefore, even in a SSP Cube type network, by representing that there is no circulation in the channel dependency graph, it is verified that deadlock free routing is performed.

A characteristic of a SSP Cube type network is that when building a network it is possible to determine node numbers to be assigned to nodes, and channel numbers to be assigned to channels. In addition, the routing in a SSP Cube type network is the dimension order routing in which data is transferred from a transmitting node to a destination node by using a channel in descending order of the channel number. Therefore, when drawing a channel dependency graph, there is no circulation at all between channels. As a result, it can be verified that deadlock free routing is performed.

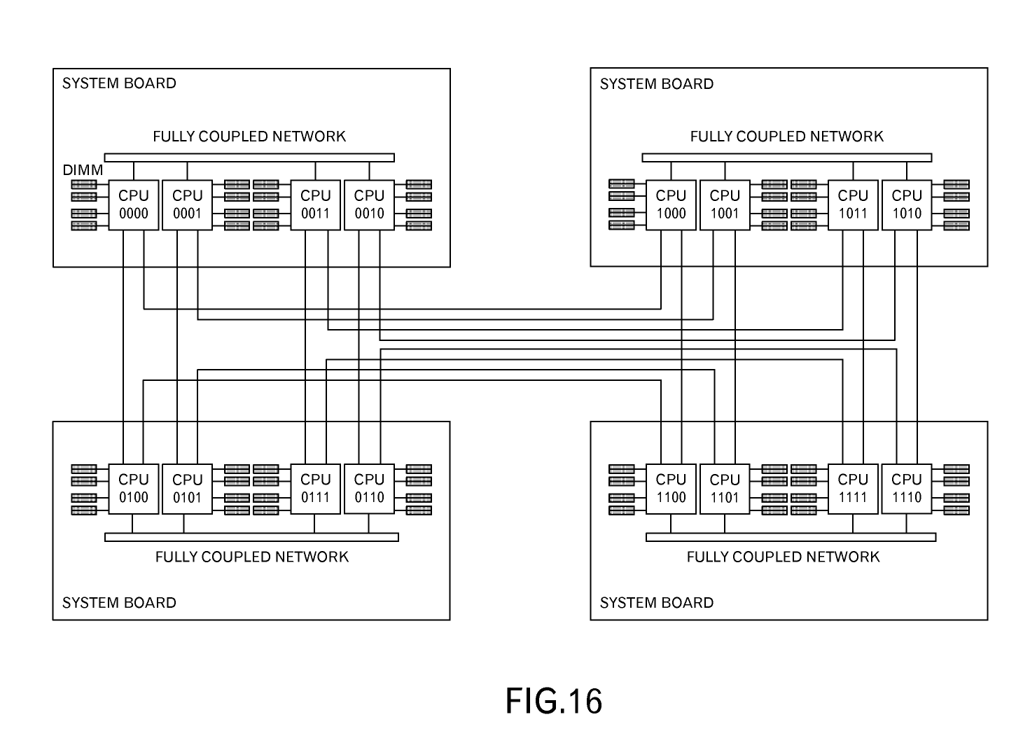

Next, an application example of a SSP Cube type network will be explained. FIG. 16 illustrates an example of configuration when a 16-node SSP Cube type network is applied to a computer system. In the example in FIG. 16, physical wiring lines are provided so that four CPUs (Central Processing Units) that are mounted on the same system board are fully coupled, and a multi-area is formed. Here, the physical wiring lines are interconnected channels.

In actual, how node numbers will be assigned depends on requirements and rules of a computer system, however, using the configuration such as described above is effective in making it possible to particularly improve the communication efficiency on a system board. This is because each CPU can access a DIMM (Dual Inline Memory Module) that is subordinated to another CPU on the same system board in one hop. This is advantageous in the case of parallel processing in each area to execute a single application on one system board, and when compared to using a fully coupled network, it is possible to greatly reduce the amount of physical wiring lines.

Although one embodiment of this technique was explained, this technique is not limited to this embodiment. For example, the functional block diagram of the aforementioned processor 1 may not correspond to actual program module configuration.

Moreover, as for the processing flow described above, as long as the processing result does not change, the order of the processing steps may be changed. Furthermore, the parallel execution of the plural processing steps may be carried out.

The aforementioned embodiment is outlined as follows:

An information processing system relating to a first aspect of the embodiments has 2ⁿ nodes that are connected in a manner of an n-dimensional hyper cube, wherein the n is a natural number equal to or greater than 3. Then, a channel is provided between each node of specific nodes satisfying a predetermined condition among the 2ⁿ nodes and each of the specific nodes other than the node, and the predetermined condition is a condition that all numerical values of digits other than a last digit and a second last digit of anode number are same, in case where an n-digit binary node number is assigned to each of the 2ⁿ nodes so that a Hamming distance between directly connected nodes is 1.

According to this configuration, compared with a conventional hyper cube type information processing system, it becomes possible to enhance the communication efficiency while effectively reducing the average number of hops and/or the maximum number of hops, without largely increasing the number of channels.

A routing method relating to a second aspect of the embodiments is executed by a first node of 2ⁿ nodes included in an information processing system, wherein the 2ⁿ nodes are connected in a manner of an n-dimensional hyper cube, the n is a natural number equal to or greater than 3, a channel is provided between each node of specific nodes satisfying a first condition among the 2ⁿ nodes and each of the specific nodes other than the node, and the first condition is a condition that all numerical values of digits other than a last digit and a second last digit of a node number are same, in case where an n-digit binary node number is assigned to each of the 2^{r} nodes so that a Hamming distance between directly connected nodes is 1. Moreover, this routing method includes (A) when data is transmitted to a destination node, determining whether or not a second condition is satisfied, wherein the second condition is a condition that a numerical value of a last digit of a node number of the first node is different from a numerical value of a last digit of a node number of a destination node, and a numerical value of a second last digit of the node number of the first node is different from a numerical value of a second last digit of the node number of the destination node; and (B) in response to determining that the second condition is satisfied, transmitting data to be transmitted to the destination node to a second node through a channel provided between the first node and the second node, wherein the second node has a node number whose numerical value of a last digit is an inverted numerical value of the numerical value of the last digit of the node number of the first node, whose numerical value of a second last digit is an inverted numerical value of the numerical value of the second last digit of the node number of the first node, and whose numerical values of digits other than the last digit and the second last digit are same as numerical values of digits other than the last digit and the second last digit of the node number of the first node.

According to this configuration, compared with the routing (e.g. e-cube routing) in the conventional hyper cube type information processing system, it becomes possible to transfer data to the destination node with a less number of hops.

Moreover, the aforementioned method may further include: (C) in response to determining that the second condition is not satisfied, comparing the node number of the first node with the node number of the destination node digit-by-digit in sequence from a most significant digit to identify a first digit whose numerical values are firstly found to be different; and (D) transmitting the data to be transmitted to the destination node to a node to which a node number whose numerical value of the first digit is inverted in the node number of the first node is assigned. Thus, it is possible to carry out the routing so that the data reaches the destination node with the least number of hops.

Incidentally, it is possible to create a program causing a hardware (e.g. processor) to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing system, comprising:
2ⁿ nodes that are connected in a manner of an n-dimensional hyper cube, wherein the n is a natural number equal to or greater than 3, and
wherein a channel is provided between each node of specific nodes satisfying a predetermined condition among the 2ⁿ nodes and each of the specific nodes other than the node, and
wherein the predetermined condition is a condition that all numerical values of digits other than a last digit and a second last digit of a node number are same, in case where an n-digit binary node number is assigned to each of the 2ⁿ nodes so that a Hamming distance between directly connected nodes is 1.

2. A routing method, comprising:
determining, by using a first node of 2ⁿ nodes included in an information processing system, whether or not a first condition is satisfied, wherein the 2ⁿ nodes are connected in a manner of an n-dimensional hyper cube, the n is a natural number equal to or greater than 3, a channel is provided between each node of specific nodes satisfying a second condition among the 2ⁿ nodes and each of the specific nodes other than the node, the second condition is a condition that all numerical values of digits other than a last digit and a second last digit of a node number are same, in case where an n-digit binary node number is assigned to each of the 2ⁿ nodes so that a Hamming distance between directly connected nodes is 1, and the first condition is a condition that a numerical value of a last digit of a node number of the first node is different from a numerical value of a last digit of a node number of a destination node, and a numerical value of a second last digit of the node number of the first node is different from a numerical value of a second last digit of the node number of the destination node; and
in response to determining that the first condition is satisfied, transmitting, by using the first node, data to be transmitted to the destination node to a second node through a channel provided between the first node and the second node, wherein the second node has a node number whose numerical value of a last digit is an inverted numerical value of the numerical value of the last digit of the node number of the first node, whose numerical value of a second last digit is an inverted numerical value of the numerical value of the second last digit of the node number of the first node, and whose numerical values of digits other than the last digit and the second last digit are same as numerical values of digits other than the last digit and the second last digit of the node number of the first node.

3. The routing method as set forth in claim 2, further comprising:
in response to determining that the first condition is not satisfied, comparing, by using the first node, the node number of the first node with the node number of the destination node digit-by-digit in sequence from a most significant digit to identify a first digit whose numerical values are firstly found to be different; and
transmitting, by using the first node, the data to be transmitted to the destination node to a node to which a node number whose numerical value of the first digit is inverted in the node number of the first node is assigned.

4. A computer-readable, non-transitory storage medium storing a program for causing a first node of 2ⁿ nodes included in an information processing system to execute a procedure, the procedure comprising:
determining whether or not a first condition is satisfied, wherein the 2ⁿ nodes are connected in a manner of an n-dimensional hyper cube, the n is a natural number equal to or greater than 3, a channel is provided between each node of specific nodes satisfying a second condition among the 2ⁿ nodes and each of the specific nodes other than the node, the second condition is a condition that all numerical values of digits other than a last digit and a second last digit of a node number are same, in case where an n-digit binary node number is assigned to each of the 2ⁿ nodes so that a Hamming distance between directly connected nodes is 1, and the first condition is a condition that a numerical value of a last digit of a node number of the first node is different from a numerical value of a last digit of a node number of a destination node, and a numerical value of a second last digit of the node number of the first node is different from a numerical value of a second last digit of the node number of the destination node; and
in response to determining that the first condition is satisfied, transmitting data to be transmitted to the destination node to a second node through a channel provided between the first node and the second node, wherein the second node has a node number whose numerical value of a last digit is an inverted numerical value of the numerical value of the last digit of the node number of the first node, whose numerical value of a second last digit is an inverted numerical value of the numerical value of the second last digit of the node number of the first node, and whose numerical values of digits other than the last digit and the second last digit are same as numerical values of digits other than the last digit and the second last digit of the node number of the first node.

5. An information processing system, comprising:
2ⁿ nodes that are connected in a manner of an n-dimensional hyper cube, wherein the n is a natural number equal to or greater than 3, and
wherein an n-digit binary node number is assigned to each of the 2ⁿ nodes so that a Hamming distance between directly connected nodes is 1, and
a channel is provided between each node of specific nodes satisfying a first condition among the 2ⁿ nodes and each of the specific nodes other than the node, and the first condition is a condition that all numerical values of digits other than a last digit and a second last digit of a node number are same, and
each of the 2ⁿ nodes comprises:
a memory; and
a processor using the memory and configured to execute a procedure, the procedure comprising:
determining whether or not a second condition is satisfied, wherein the second condition is a condition that a numerical value of a last digit of a node number of the first node is different from a numerical value of a last digit of a node number of a destination node, and a numerical value of a second last digit of the node number of the first node is different from a numerical value of a second last digit of the node number of the destination node; and
in response to determining that the second condition is satisfied, transmitting data to be transmitted to the destination node to a second node through a channel provided between the first node and the second node, wherein the second node has a node number whose numerical value of a last digit is an inverted numerical value of the numerical value of the last digit of the node number of the first node, whose numerical value of a second last digit is an inverted numerical value of the numerical value of the second last digit of the node number of the first node, and whose numerical values of digits other than the last digit and the second last digit are same as numerical values of digits other than the last digit and the second last digit of the node number of the first node.
